(19) United States
(12) Patent Application Publication
(10) Pub. No.: US 2014/0307336 A1
(43) Pub. Date: Oct. 16, 2014

(54) THIN-TYPE WIDE-ANGLE IMAGING LENS ASSEMBLY WITH THREE LENSES

(71) Applicant: Ability Opto-Electronics Technology Co., Ltd., Taichung County (TW)

(72) Inventor: Chien-hsun LAI, Taichung City (TW)

(73) Assignee: Ability Opto-Electronics Technology Co., Ltd., Taichung County (TW)

(21) Appl. No.: 14/045,341

(22) Filed: Oct. 3, 2013

(30) Foreign Application Priority Data
Apr. 15, 2013 (TW) 102206794

(51) Int. Cl. G02B 13/00

(52) U.S. Cl. CPC G02B 13/0015; G02B 13/0035
USPC 359/716; 359/739

(57) ABSTRACT

A thin-type wide-angle imaging lens assembly comprises a fixing diaphragm and an optical set including three lenses. An arranging order from an object side to an image side is: a first lens; a second lens; a third lens; and the diaphragm disposed at any position between an object and an image. By the concatenation between the lenses and the adapted curvature radius, thickness/interval, refractivity, and Abbe numbers, the assembly attains a shorter height and a better optical aberration.

The current application claims a foreign priority to the patent application of Taiwan No. 102206794 filed on Apr. 15, 2013.

### BACKGROUND OF THE INVENTION

1. Field of the Invention

The present invention relates to a thin-type wide-angle imaging lens assembly with three lenses, in particular to a lens structure attaining a shorter height and a high resolution by curvature, interval and optical parameter between each lens.

2. Description of the Related Art

The conventional lens structure adopts an image display lens assembly which is applied to cell phone, smart phone, notebook, and webcam. The electronic products are developed to become lighter, thinner, shorter, and smaller and provide with higher efficiency. A video sensor of the image display lens assembly, such as Charge Coupled Device (CCD) or Complementary Metal Oxide Semiconductor (CMOS), is also developed for more pixels, so the lens structure is ceaselessly developed to be provided with compactness and higher resolution.

Therefore, the present invention is disclosed in accordance with a lens structure with multi-lens for a demand of the development of the image display lens assembly, especially to an imaging lens assembly of a lens structure with at least three lenses.

### SUMMARY OF THE INVENTION

In view of the conventional lens structure that has big volume and lack of efficiency, a wide-angle imaging lens assembly with three lenses is disclosed.

It is an object of the present invention to provide a thin-type wide-angle imaging lens assembly with three lenses, which comprises a fixing diaphragm and an optical set. The optical set includes a first lens, a second lens, and a third lens, an arranging order thereof from an object side to an image side is: the first lens with a negative refractive power defined near an optical axis and two surfaces of the first lens defined as concave surfaces disposed near the optical axis, and the two surfaces are spherical or aspheric; the second lens with a positive refractive power defined near the optical axis and two surfaces of the second lens defined as convex surfaces disposed near the optical axis, and the two surfaces of the second lens are spherical or aspheric; the third lens having a lens with a negative refractive power defined near the optical axis and a concave surface directed toward the object side, and two surfaces of the third lens are spherical or aspheric; and the diaphragm is disposed at any position between an object and an image.

The imaging lens assembly satisfies the following conditional expression: 0.05<f/TL<5. The TL is defined as a distance from a top point of the object side of the first lens on the optical axis to an imaging surface side. The f is defined as a focal length of the entire lens assembly.

The imaging lens assembly satisfies the following conditional expression: 0.5<TL/Dg<5. The TL is defined as the distance from the top point of the object side of the first lens on the optical axis to the imaging surface side. The Dg is defined as a diagonal length of a maximum using visual angle of the lens assembly imaged on the imaging surface.

A shape of the aspheric surface satisfies a formula of:

$$z = \frac{{ch}^{2}}{1 + {[ 1 - ( k + 1 ) {c}^{2} {h}^{2} ]}^{0.5}} + A {h}^{4} + {Bh}^{6} + {Ch}^{8} + {Dh}^{10} + {Eh}^{12} + {Fh}^{14} + {Gh}^{16} + {Hh}^{18} + {Jh}^{20} + …$$

The z is defined as a position value about a location at a height of h along a direction of the optical axis referring to a surface top point. The k is defined as a conic constant. The c is defined as a reciprocal of a radius of a curvature. The A, B, C, D, E, F, G, etc. are defined as high-order aspheric surface coefficients.

The present invention is characterized in that a lens structure attains a shorter height and a high resolution by curvature, interval, and optical parameter between each lens.

### BRIEF DESCRIPTION OF THE DRAWINGS

FIG. 1 is a schematic view showing an optical structure of a preferred embodiment of the present invention;

FIG. 2 is a schematic view showing an astigmatic aberration of the preferred embodiment of the present invention;

FIG. 3 is a schematic view showing a distorted aberration of the preferred embodiment of the present invention; and

FIG. 4 is a schematic view showing a spherical aberration of the preferred embodiment of the present invention.

### DETAILED DESCRIPTION OF THE PREFERRED EMBODIMENTS

The detail contents and technical descriptions of the present invention are described upon reading the following preferred embodiments, but it is understood that the embodiments only show the examples as they should not be explained to restrict the scope of the present invention.

The present invention provides an imaging lens structure, in particular to a lens structure attaining a shorter height and a high resolution by a curvature, an interval, and an optical parameter between each lens.

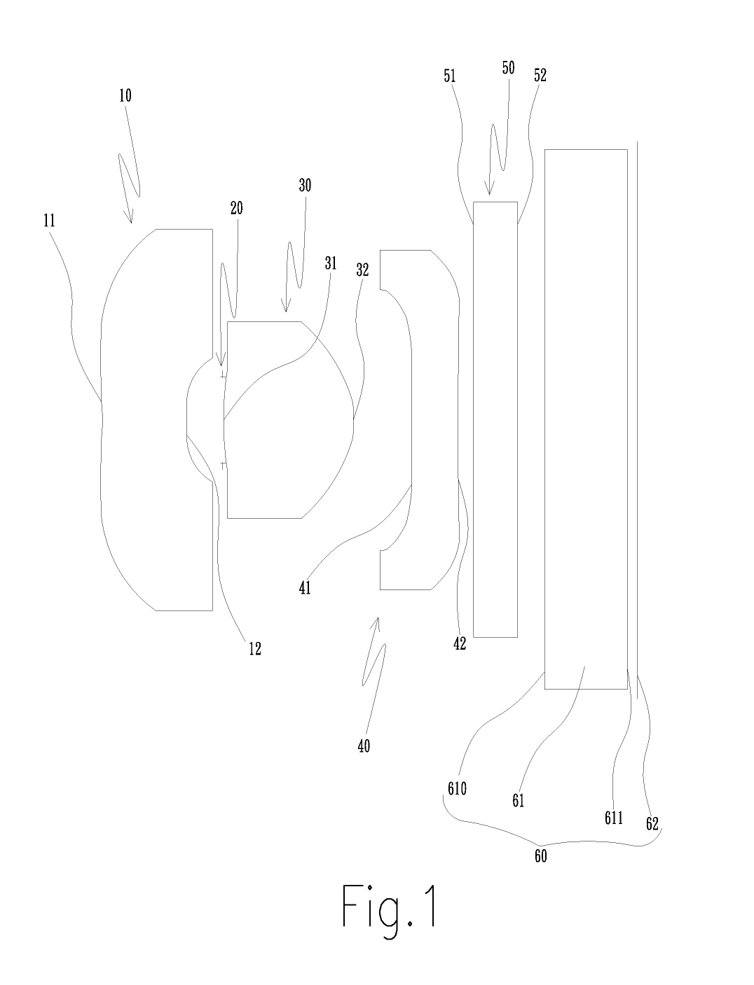

Referring to FIG. 1, a schematic view of an optical structure of a thin-type wide-angle imaging lens assembly with three lenses of the present invention is shown. The structure of the imaging lens comprises a fixing diaphragm 20 and an optical set. The optical set includes a first lens 10, a second lens 30, and a third lens 40, an arranging order thereof from an object side to an image side is: the first lens 10 with a negative refractive power defined near an optical axis and two surfaces thereof defined as concave surfaces disposed near the optical axis, and the two surfaces are spherical or aspheric; the second lens 30 with a positive refractive power defined near the optical axis and two surfaces thereof defined as convex surfaces disposed near the optical axis, and the two surfaces are spherical or aspheric; the third lens 40 having a lens with a negative refractive power defined near the optical axis and a concave surface directed toward the object side, and two surfaces of the third lens 40 are spherical or aspheric; the fixing diaphragm 20 disposed at any position between an object and an image; a filter unit 50 filtering light with specific wave length, the filter unit 50 is adopted by an infrared stopping filter unit applied to a visible light image, or a visible light stopping filter unit for filtering the visible light, and a wave length of the light passing therethrough is 780-1050 mm and applied to the infrared light image of the invisible light; and an image sensor 60 (an imaging surface side) used for receiving a digital signal transformed by an infrared invisible light image of the filter unit. The image sensor 60 includes a flat protection lens 61 and a video sensor 62. The video sensor 62 is preferably adopted by Charge Coupled Device (CCD) or Complementary Metal Oxide Semiconductor (CMOS).

The imaging lens assembly satisfies the following conditional expression: 0.05<f/TL<5. The TL is defined as a distance from a top point of the object side of the first lens on the optical axis to the imaging surface side. The f is defined as a focal length of the entire lens assembly.

The imaging lens assembly satisfies the following conditional expression: 0.5<TL/Dg<5. The TL is defined as the distance from the top point of the object side of the first lens on the optical axis to the imaging surface side. The Dg is defined as a diagonal length of a maximum using visual angle of the lens assembly imaged on the imaging surface.

The first lens 10 includes a first surface 11 facing an object side and a second surface 12 facing the imaging surface side. The first surface 11 is defined as a concave surface disposed near the optical axis opposite to the object side. The second surface 12 is defined as a concave surface disposed near the optical axis opposite to the imaging surface side. The second lens 30 includes a third surface 31 facing the object side and a fourth surface 32 facing the imaging surface side. The third surface 31 is defined as a convex surface disposed near the optical axis opposite to the object side. The fourth surface 32 is defined as a convex surface opposite to the imaging surface side. The third lens 40 includes a fifth surface 41 facing the object side and a sixth surface 42 facing the imaging surface side. The fifth surface 41 is defined as a concave surface disposed near the optical axis opposite to the object side. The sixth surface 42 is defined as a concave surface disposed near the optical axis opposite to the imaging surface side. The above-mentioned first surface 11, second surface 12, third surface 31, fourth surface 32, fifth surface 41, and sixth surface 42 are aspheric, thereby correcting the spherical aberration and the image aberration for providing with a characteristic of low tolerance sensitivity.

A shape of the aspheric surface of the imaging lens assembly satisfies a formula of:

$$z = \frac{{ch}^{2}}{1 + {[ 1 - ( k + 1 ) {c}^{2} {h}^{2} ]}^{0.5}} + A {h}^{4} + {Bh}^{6} + {Ch}^{8} + {Dh}^{10} + {Eh}^{12} + {Fh}^{14} + {Gh}^{16} + {Hh}^{18} + {Jh}^{20} + …$$

The z is defined as a position value about a location at a height of h along a direction of the optical axis referring to a surface top point. The k is defined as a conic constant. The c is defined as a reciprocal of a curvature. The A, B, C, D, E, F, G, etc. are defined as high-order aspheric surface coefficients.

In an ultra-wide-angle micro-optical image capturing device of the present invention, the fixing diaphragm 20 is disposed at any position between an object and an image for getting an incident beam. The first lens 10 and the third lens 40 are adopted by lenses with negative refractive power defined near the optical axis, and the second lens 30 is adopted by a lens with positive refractive power defined near the optical axis. The first lens 10 adopts the first surface 11 concavely defined opposite to the object side and disposed near the optical axis for assembling the external incident beam with ultra-wide-angle so as to keep the beam on the second surface 12 of the first lens 10, thereby presenting a function of the aspheric surface, correcting the aberration, reducing the tolerance sensitivity, and rendering the device provide with ultra-wide-angle with an image-capture angle over 130°. The third surface 31 defined on the second lens 30 as a convex surface disposed near the optical axis and opposite to the object side is then expanded. The fourth surface 32 is defined as a lens with positive refractive power defined near the optical axis and a convex surface opposite to the imaging surface side. The third lens 40 radiates via the fifth surface 41 disposed near the optical axis and provided with two surfaces concavely defined toward the imaging surface side, so that the beam is able to be spread on the sixth surface 42 with a larger dimension. That is to say, the incident beam is expanded by the third surface 31 so as to be spread on the sixth surface 42 with a larger dimension. The second lens 30 is defined as a meniscus shape for presenting the function of aspheric surface, correcting the aberration, and reducing tolerance sensitivity.

The aspheric surface not only corrects the spherical aberration and the image aberration but also reduces the full length of the lens optical system. The first lens 10, the second lens 30, and the third lens 40 are preferably adopted by plastic, which is conducive to an elimination of the aberration and a reduction in the weight of the lens. The entire optical system only uses three plastic lenses and benefits a mass production. The optical system also provides with the low tolerance sensitivity and a large depth of field and attains an assemblage tolerance less than a usable scope of a depth of focus of an optical focusing. Accordingly, the optical system does not need to focus in practice. The optical system is also easy to be manufactured and assembled to meet the requirement of mass production. The filter unit 50 used for filtering the visible light and passing the infrared invisible light forms an ultra-wide-angle micro-optical image capturing device capable of capturing the images.

By the concatenation between the above-mentioned surfaces of lenses and the adapted curvature radius, thickness/interval, refractivity, and Abbe numbers, the assembly attains a shorter height and a better optical aberration.

Due to the above-mentioned technique of the present invention, it is able to be practiced in accordance with the following values:

Basic lens data of the preferred embodiment

| | | | Thickness/ | | |
|---|---|---|---|---|---|
| | | Curvature | Interval | Refrac- | Abbe |
| | | radius | (Thick- | tivity | number |
| Surfaces | | (Radius) | ness) | (Nd) | (Vd) |
| First lens | First surface | −1.86 | 0.41 | 1.53460 | 56.07 |
| 10 | 11 | | | | |
| | Second | 0.98 | 0.18 | | |
| | surface 12 | | | | |
| Fixing diaphragm 20 | | ∞ | 0 | | |
| Second | Third surface | 1.91 | 0.63 | 1.585 | 29.9 |
| lens 30 | 31 | | | | |
| | Fourth | −0.43 | 0.29 | | |
| | surface 32 | | | | |
| Third lens | Fifth surface | −5.23 | 0.22 | 1.585 | 29.9 |
| 40 | 41 | | | | |
| | Sixth surface | 7.24 | 0.08 | | |
| | 42 | | | | |
| Filter unit | Seventh | ∞ | 0.21 | 1.516800 | 64.167336 |
| 50 | surface 51 | | | | |
| | Eighth | ∞ | 0.13 | | |
| | surface 52 | | | | |
| Flat | Ninth | ∞ | 0.40 | 1.516800 | 64.167336 |
| protection | surface 610 | | | | |
| lens 61 | Tenth | ∞ | 0.05 | | |
| | surface 611 | | | | |

The filter unit 50 has a thickness of 0.21 mm and is adopted by a visible light stopping filter unit. A wave length of the light passing therethrough is 850 mm. A thickness of the flat protection lens 61 is 0.4 mm.

The values of the aspheric surface of the preferred embodiment are listed as follows: The first surface 11 (k=−159.95)

### A: 0.6608481

### B: −0.4658657

### C: 0.1112175

### D: 0.1809292

### E: 0.0074167

### F: −0.0035157

### G: 0.0009258

The second surface 12 (k=9.59)

### A: 5.1903467

### B: 8.1371742

### C: −393.8628

### D: 4052.2912

### E: −0.3576766

### F: 0.4025124

### G: −0.4435454

The third surface 31 (k=−80.52)

### A: 2.3677634

### B: −24.061603

### C: 231.7739

### D: −1007.5218

### E: 10.386996

### F: −54.147325

### G: 95.656751

The fourth surface 32 (k=−2.13)

### A: −1.7012505

### B: 1.1659933

### C: 0.8690686

### D: 38.38493

### E: 0.0424579

### F: −0.0510908

### G: −0.0817919

The fifth surface 41 (k=65.83)

### A: 0.3155698

### B: −1.0385313

### C: −2.3450046

### D: −0.9335597

### E: −0.0013162

### F: 0.0007198

### G: 0.0019534

The sixth surface 42 (k=75.33)

### A: 0.0438380

### B: −0.6354896

### C: −0.3103171

### D: 0.1757097

### E: −0.0759811

### F: −0.0245816

### G: −0.001721

According to the above-mentioned values, the related exponent of performance of the micro-image capturing lens is: f=0.81 mm; TL=2.60 mm; f/TL=0.31; Dg=2.4 mm; TL/Dg=1.08.

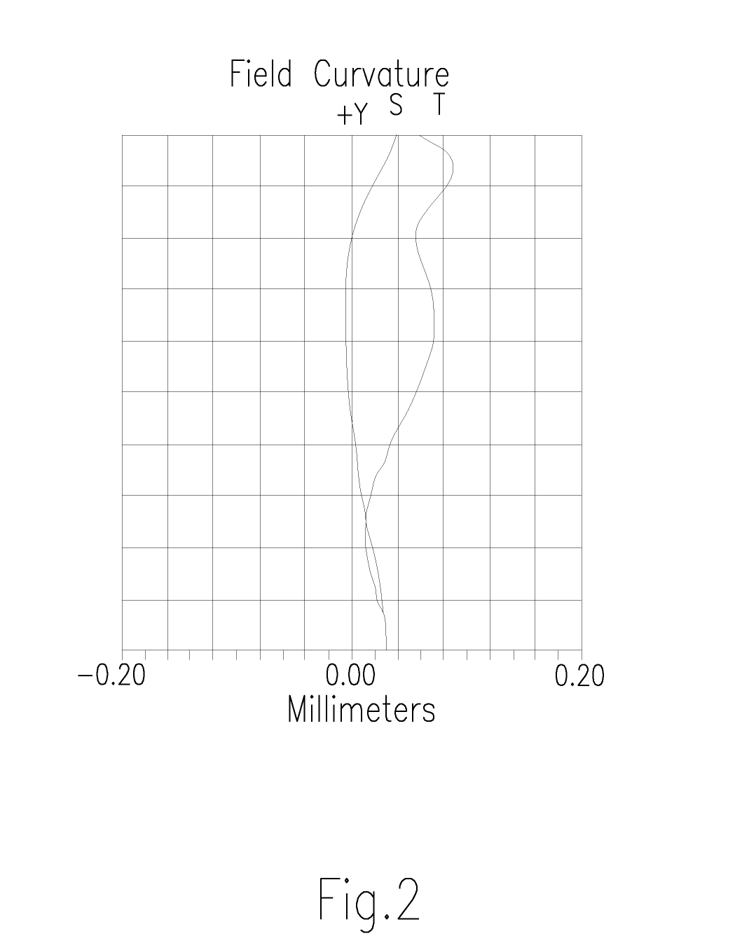

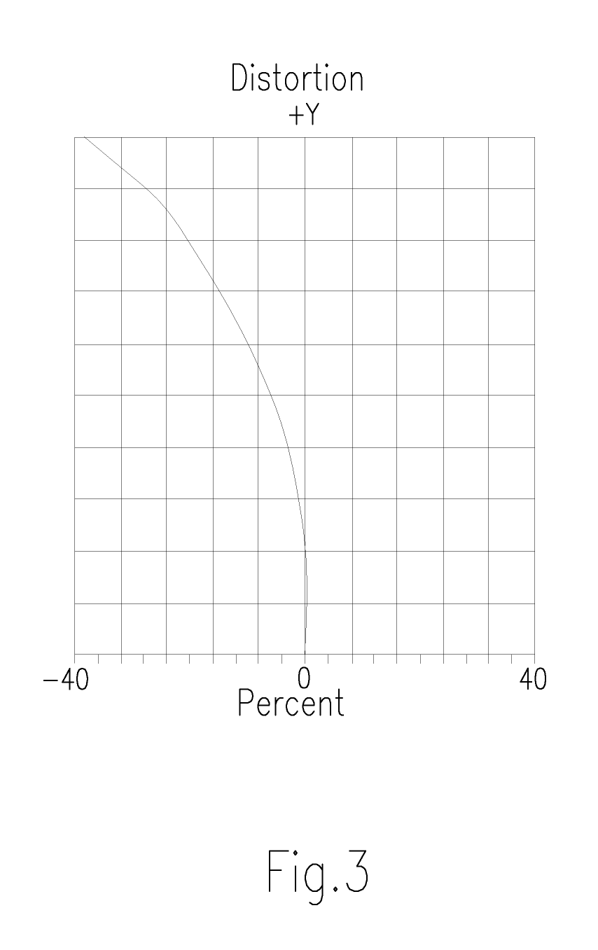

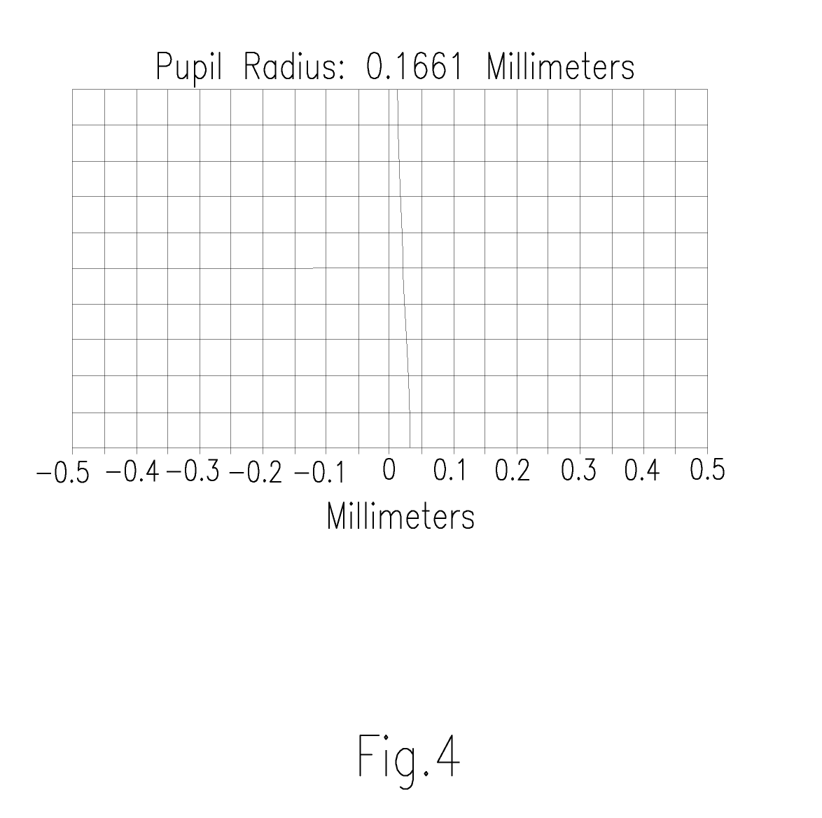

Referring to FIG. 2, a schematic view of an astigmatic aberration of the preferred embodiment of the present invention is shown. Referring to FIG. 3, a schematic view of a distorted aberration of the preferred embodiment of the present invention is shown. Referring to FIG. 4, a schematic view of a spherical aberration of the preferred embodiment of the present invention is shown. The measured astigmatic aberration, distorted aberration, and spherical aberration are in the standard scope and have a good optical performance and imaging quality according to the above-mentioned figures. Further, the depth of field of the device is large enough and the assemblage tolerance is less than the usable scope of a depth of focus of an optical focusing. Accordingly, the device does not need to focus in practice. By contrast, the device of the present invention is easier to be manufactured and assembled than the current similar products, thereby meeting the requirement of mass production.

The micro-optical image capturing device utilizes three aspheric lenses with the refractive power defined near the optical axis arranged as negative, positive, and negative and the filter unit 50 which filters a light with specific wave length and allows a pass of the light with the required wave length. The filter unit 50 is preferably adopted by an infrared stopping filter unit applied to the visible light image or a visible light stopping filter unit applied to the infrared light image of the invisible light.

By making use of the aspheric surface that corrects the aberration and reduces the tolerance sensitivity, not only the aberration is corrected but also the full length of the lens optical system is reduced. Further, the device provides with a ultra-wide-angle with an image capturing angle over 130°. The first, second, and third lenses are preferably adopted by plastic, which is conducive to an elimination of the aberration and a reduction in the weight of the lens. The optical system uses only three plastic lenses and benefits a mass production. The optical system also provides with the low tolerance sensitivity and a fine imaging quality. Furthermore, the optical system is easy to be manufactured and assembled to meet the requirement of mass production.

While we have shown and described the embodiment in accordance with the present invention, it should be clear to those skilled in the art that further embodiments may be made without departing from the scope of the present invention.

I claim:

1. A thin-type wide-angle imaging lens assembly with three lenses comprising a fixing diaphragm and an optical set; said optical set including a first lens, a second lens, and a third lens, an arranging order thereof from an object side to an image side being:
said first lens with a negative refractive power defined near an optical axis and two surfaces of said first lens defined as concave surfaces disposed near said optical axis; said two surfaces being spherical or aspheric;
said second lens with a positive refractive power defined near said optical axis and two surfaces of said second lens defined as convex surfaces disposed near said optical axis; said two surfaces being spherical or aspheric;
said third lens with a lens having a negative refractive power defined near said optical axis and a concave surface directed toward said object side, and two surfaces of said third lens being spherical or aspheric; and
said diaphragm disposed at any position between an object and an image.

2. The thin-type wide-angle imaging lens assembly with three lenses as claimed in claim 1 further satisfies the following conditional expression: 0.05<f/TL<5, wherein said TL is defined as a distance from a top point of said object side of said first lens on said optical axis to an imaging surface side, said f is defined as a focal length of said entire lens assembly.

3. The thin-type wide-angle imaging lens assembly with three lenses as claimed in claim 1 further satisfying the following conditional expression: 0.5<TL/Dg<5, wherein said TL is defined as said distance from a top point of said object side of said first lens on said optical axis to an imaging surface side, and said Dg is defined as a diagonal length of a maximum using visual angle of said lens assembly imaged on said imaging surface.
